(19) United States
(12) Patent Application Publication
(10) Pub. No.: US 2023/0371424 A1
(43) Pub. Date: Nov. 23, 2023

(54) CUTTING UNIT WITH DOUBLE KNIFE SYSTEM AND MOVABLE SLIDING SURFACE

(71) Applicant: Carl Geringhoff GmbH & Co. Kommanditgesellschaft, Ahlen (DE)

(72) Inventors: CHRISTIAN BROX, Ascheberg (DE); DIRK WEBERMANN, Senden (DE); STEFFEN SUDHUES, Ahlen (DE); MICHAEL POKRIEFKE, Hude (DE)

(21) Appl. No.: 18/320,067

(22) Filed: May 18, 2023

(30) Foreign Application Priority Data
May 20, 2022 (DE) DE102022112818.0

(51) Int. Cl. A01D 34/135; A01D 57/20

(52) U.S. Cl. CPC A01D 34/135; A01D 57/20; A01D 57/02

(57) ABSTRACT

In order to reduce crop losses, a double knife cutting system (11) is configured on the knife bar (6), where the double knife cutting system (11) includes a first part of the knife blades (18a) present on the cutting unit (2) are fastened to a first knife back (20a), this first part of the knife blades (18a) together with the first knife back (20a) forming the upper knife (22), and a second part of the knife blades (18b) present on the cutting unit (2) being fastened to a second knife back (20b), this second part of the knife blades (18b) together with the second knife back (20b) forming the lower knife (24), the upper knife (22) and the lower knife (24) being driven in opposite directions, and the sliding surface (14) being configured as a bar (16) which is connected in a stationary manner to the upper knife (22).

### CROSS REFERENCE TO RELATED APPLICATIONS

This application claims priority under 35 U.S.C. § 119 to German Patent Application DE 10 2022 112 818.0, filed May 20, 2022, which is herein incorporated by reference in its entirety, including without limitation, the specification, claims, and abstract, as well as any figures, tables, appendices, or drawings thereof.

### FIELD OF THE INVENTION

The present invention relates to a cutting unit for attachment to a combine harvester.

### BACKGROUND OF THE INVENTION

The background description provided herein gives context for the present disclosure. Work of the presently named inventors and aspects of the description that may not otherwise qualify as prior art at the time of filing are neither expressly nor impliedly admitted as prior art.

A cutting unit of the generic type is known from document DE 10 2015 110 746 A1. A Draper cutting unit is disclosed therein, the depositing surface of which is configured on the respective upwardly pointing side of a plurality of belt conveyors which are driven in circulation. The cutting unit is provided with a knife bar on which stationary knife blades which are mounted on the knife bar interact with knife blades which are attached to a lifting rod which is arranged transversely with respect to the working direction of the cutting unit and is driven movably so as to oscillate in the direction of extent. As a result of the contact of the stalks and/or infructescences of the harvested crops with parts of the cutting unit such as, for example, stalk dividers, the knife bar, the reel, or other components, it can occur in the case of extremely ripe and dry crops that grains are detached directly from the infructescences of the stalk material and fall to the ground before they are collected by the depositing surface. Grains of this type lying on the ground can no longer be returned to the harvested crop stream and are lost as harvested crop yield. It also happens that, although grains fall onto the depositing surface, they then fall forward from the depositing surface onto the ground and are likewise lost as harvested crop yield as a result. It can equally happen that, although cut stalk material is deposited cleanly on the depositing surface, grains are detached and fall down forward from the cutting unit. Finally, fruits which grow in husks such as, for example, legumes such as soybeans or rape, are also harvested as stalk material. During harvesting, in particular cutting and subsequent depositing and conveying of the cut harvested crop on the belt conveying apparatus, the husks burst open, and the grains are hurled into the surroundings as a result. As a result, grains can also fall as harvested crops from the belt conveying apparatus onto the farmland soil and can be lost as harvested crop yield.

In order to reduce the grain losses in the region of the knife bar, document DE 10 2015 110 746 A1 proposes configuring a sliding surface which is of obliquely inclined configuration in the conveying direction of the harvested crop in the transition region from the knife bar to the depositing surface, and providing air outlet openings in the siding surface, from which air outlet openings an upwardly directed air stream exits which catches falling grains and blows them onto the depositing surface. However, the operating results of this solution still appear to be improvable in particularly difficult harvesting conditions.

Document DE 10 2018 119 326 B3 has disclosed a double knife cutting system, in the case of which not only one lifting rod with the knife blades fastened to it, but rather two lifting rods which, with the knife blades fastened thereto, form an upper and a lower knife are used. The upper and lower knife are driven movably in opposite directions. Thus, there exists a need in the art for a cutting apparatus for a harvester machine that can be mounted and repaired in a cost-effective manner.

### SUMMARY OF THE INVENTION

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

The present invention relates to a cutting unit for attachment to a combine harvester with a frame, a knife bar, a depositing surface for depositing the cut stalk material, conveying apparatuses for conveying away the cut stalk material, drive apparatuses for driving the knife bar and the conveying apparatuses, and a sliding surface, inclined obliquely in the conveying direction of the harvested crops, in the transition region from the knife bar to the depositing surface.

It is the object of the present invention to reduce the grain losses in the transition region between the knife bar and the depositing surface even in particularly difficult harvesting conditions.

The object is achieved for a cutting unit of the generic type by a double knife cutting system being configured on the knife bar, in the case of which double knife cutting system a first part of the knife blades present on the cutting unit are fastened to a first knife back, this first part of the knife blades together with the first knife back forming the upper knife, and a second part of the knife blades present on the cutting unit being fastened to a second knife back, this second part of the knife blades together with the second knife back forming the lower knife, the upper knife and the lower knife being driven in opposite directions, and the sliding surface being configured as a bar which is connected in a stationary manner to the upper knife.

If a double knife cutting system is used, crop lifters and knife fingers, in which the lifting rod and the knife blades fastened to it are guided, can be dispensed with. Since, in the case of a double knife cutting system, both the upper knife and the lower knife are driven movably in an oscillating manner, their lifting travels are shortened, and the movement speeds are lower. This results in the smoother running of the cutting system, as a result of which fewer grains are shaken out of the crops during the cutting of the harvested crops. In addition, the cutting itself is cleaner and smoother, as a result of which the stalks of the harvested material are likewise moved less.

The knife blades of a double knife cutting system can also be mounted at a lower location on the cutting unit than the knife blades of a conventional cutting system with a simple lifting rod because, in the case of the double knife cutting system, crop lifters and knife fingers are not required. The cutting unit itself can be moved more closely to the ground because the knife blades of a double knife cutting system clean themselves and do not get plugged with soil if they make contact with the ground. This results in a longer drop distance of loose grains which can already lead to the loose grains landing on the depositing surface, which is pushed continuously below the cut harvested material during the forward travel of the combine harvester, and not landing on the farmland soil before the depositing surface reaches the drop line of the falling grain either. If the movement speed of the upper and lower knife in the case of half the lifting travel is greater than half as fast as the conventional cutting systems with an oscillating lifting rod, the speed can be greater in the case of harvesting with a cutting unit which is equipped with a double knife cutting system than with a conventional cutting unit, without cutting losses needing to be feared, as a result of which the depositing surface is pushed even more quickly under the falling grains, as a result of which the losses on the cutting unit are once again reduced.

It is additionally advantageous to connect the sliding surface configured as a bar in a stationary manner to the upper knife, so that it moves together with the oscillating movements of the upper knife. The bar and, therefore also, the sliding surface perform a shaking movement together with the upper knife during the harvesting work, as a result of which shaking movement, harvested crops which fall onto the sliding surface are likewise given momentum in the respective movement direction of the upper knife in the case of the contact. Since the upper knife moves very quickly and, in the process, also constantly decreases the movement speed at the stroke position ends and accelerates again and, in the process, also always changes the movement direction, the falling harvested material vibrates on the sliding surface and does not adhere to it. Since falling harvested material is kept spaced away from the sliding surface in a suspended manner in this way, it can be entrained there more easily by further cutting harvested material which sweeps past the sliding surface and can be conveyed onto the depositing surface. The sliding surface, which is moved together with the upper knife, likewise reduces the grain losses of the cutting unit in the region of the cutting system as a result. The bar can extend in one piece over the entire working width of the cutting unit, but the bar can also be divided into a plurality of parts which are placed next to one another onto the upper knife. The upper knife can also be segmented into parts, it being possible for the segments of the upper knife and the bar parts to be of equally wide configuration. The bar can be particularly sealed towards the upper knife and towards the knife bar, the depositing surface and/or toward adjacent bar parts in the case of a segmented bar, for example, by way of a sealing layer made from an elastomeric material, in order to reduce or even to prevent the passage of harvested material through the slots and joints which are then sealed.

In the combination of a double knife cutting system with a sliding surface which is connected in a stationary manner to the upper knife, it is possible for the grain losses in the cutting region of the cutting unit to be reduced, in particular under difficult harvesting conditions. The cut harvested material adheres to a lesser extent to the sliding surface, flows more readily in the direction of the depositing surface, and is overall conveyed away in the direction of the depositing surface of the cutting unit in an improved manner.

The invention can be implemented both in the case of Draper cutting units and also other cutting units with a rigid depositing surface and conveying apparatuses which sweep over it such as, for example, a conveying worm. In addition, a rotationally driven, height-adjustable, and length-adjustable reel can be provided on the cutting unit as conveying apparatus, which reel is positioned above and over the knife bar, and by way of which reel the cut harvested material is ejected in the direction of the depositing surface. The reel stabilizes and steadies the harvested material in its upper region when it is being cut, and pushes the cut harvested material in the direction of the depositing surface when the cut has taken place, and the harvested material is at this moment in danger of falling onto the farmland soil. The sliding surface, which is moved continuously forwards into the supply of harvested material to be harvested by way of the combine harvester in this case, pushes the lower parts of the cut plants in the working direction of the combine harvester at the same time, with the result that the harvested material inclines towards the depositing surface in a tilting movement and comes to lie on the depositing surface without cutting losses. As a result of the vibration of the sliding surface, the harvested material does not adhere to it, with the result that the momentum of the reel on the cut harvested material in the direction of the depositing surface is not braked by the sliding surface.

In accordance with one refinement of the invention, the upper and lower knives are held over their length in the direction of extent at the free ends of a plurality of supporting arms which are connected to the frame and can be moved with their free ends into height positions which are different from one another. In the case of this method of fastening, the cutting system can be adapted transversely over the working width of the cutting unit in a flexible manner at least approximately to an uneven ground contour, by the free ends of the supporting arms being moved upwards or downwards depending on the surface contour of the farmland soil currently being moved over in the region of the corresponding supporting arm or, in the case of a flat ground surface, remaining in their current position. The supporting arms can be mounted in a pivot bearing, for example, at their frame-side end, or the supporting arms are configured as leaf springs which are fixed on the frame, which makes corresponding spring movements at the free end of the leaf spring possible. In the case of movements of the free ends of the supporting arms, that portion of the upper and lower knives which is held by a corresponding supporting arm and the bar, which is connected fixedly to the upper knife move with the sliding surface upwards or downwards. In the case of lodged grain or other harvested material, which is to be cut close to the ground, this can be satisfactorily undercut and cut away close to the ground, even if ground depressions or elevations are situated in regions within the working width of the cutting unit. Since the bar moves together with the upper knife, the sliding surface also follows the movements, by way of which the upper and lower knives adapt to an uneven floor contour when the cutting unit is moved over the farmland soil during harvesting. In particular, the knife backs of the upper and lower knives are likewise of sufficiently flexible configuration here, with the result that they can be adapted according to the ground contour.

In accordance with one refinement of the invention, the depositing surface is configured on the upwardly pointing side of one or more belt conveyors, which are driven in circulation. In the case of a configuration of this type of the cutting unit, it is, in particular, a Draper cutting unit that conveys actively over the entire area of the upper sides of the belt conveyors. Since the circulating belts of the belt conveyors run around lateral deflection rollers in an upper and a lower run and have an unavoidably higher protruding overall height for this reason than, for example, a cutting unit recess formed from sheet metal, it is particularly helpful in the case of Draper cutting units of this type for a vertical offset between the cutting system and the surface of the upper run of the belt conveyor to be overcome by way of a sliding surface which is configured in such a way that it causes grain losses which are as small as possible.

In accordance with one refinement of the invention, distributed transversely over the working width, the bar has a number of air outlet openings which are oriented upwards and/or in the direction of the depositing surface. An air stream can exit through the air outlet openings, which air stream captures the cut harvested material or the harvested material, which is shaken out of the stalks and conveys it in the direction of the depositing surface. The level of losses of the cutting unit can be reduced by way of the air outlet openings.

In accordance with one refinement of the invention, coverings are formed in each case in the bar in the regions, in which rocker arms are situated, which coverings shield the rocker arms against harvested crops and dirt. The joints of the rocker arms are less subject to wear as a result.

In accordance with one refinement of the invention, the cutting unit is of multiple-part configuration, and the bar is of flexible and/or split configuration at the joints between the cutting unit parts. In the case of a multiple-part cutting unit, the frame is not of single-part and rigid configuration, but rather it has a plurality of frame parts which are configured such that they can be moved relative to one another and in each case cover only a part width of the overall working width of the cutting unit with their structural width. The individual frame parts can be adapted to a ground contact in an improved manner in this way. If the bar is of flexible and/or split configuration, at least at the junctures, it does not impede the adaptation movements of the individual frame parts to a changing ground contour, but nevertheless can assist a complete and reliable transfer of the harvested material onto the depositing surface at the junctures, without the risk of grain losses in the transition region between the knife bar and the depositing surface being increased significantly as a result.

In accordance with one refinement of the invention, the upper and lower knife of the double knife cutting system are drive-connected via rocker arms to a mechanism which is arranged at a location between the side walls of the cutting unit. Knife bars of a cutting unit are usually driven from the outside via mechanisms which are arranged in the region of the side walls. In the case of a central drive of the upper and lower knives of the double knife cutting system, this results in a more homogeneous distribution of the drive power over the working width of the upper and lower knives in the cutting unit. The drive shafts and/or hydraulic hoses, by way of which the drive power is conducted from a combine harvester-side drive source through the cutting unit to the mechanism, can be arranged closer to the cutting unit center in the cutting unit. If they have to be routed to the outer cutting unit sides, the frame would be loaded with correspondingly higher weights and lever forces. This is avoided by way of a more pronounced centered arrangement of the mechanism. Here, the mechanism does not have to be geometrically arranged precisely centrally in the cutting unit; a lateral offset with respect to the center is possible. A plurality of mechanisms can also be provided, which in each case, drive a set of upper and lower knives which extend only over a part working width of the cutting unit. Thus, there can be two mechanisms, for example, for a twelve-meter-wide cutting unit, which mechanisms each drive a set of six-meter-wide upper and lower knives, their mechanisms being arranged, for example, at a position which is offset inwards from the side walls by three meters or four meters. There can also be a first mechanism, which is arranged at a location between the side walls and with which only the upper knife is driven, and a second mechanism, at another location between the side walls, with which only the lower knife is driven.

In accordance with one refinement of the invention, the output shafts for driving the rocker arms are guided outwards out of the mechanism housing on the upper side of the mechanism and the rocker arms extend in a plane above the plane of the upper and lower knives from the output shafts in the direction of the upper and lower knives. As a result of the arrangement of the drive train from the mechanism to the upper and lower knives below the plane of the upper and lower knives, the upper and lower knives can be installed into the cutting unit at a very low location at the bottom on the knife bar, and the cutting unit itself maintains a highly flat overall design below the plane of the upper and lower knives, with the result that the upper and lower knives can be guided very close to the ground surface during harvesting operation, and the upper and lower knives are subjected to a lower risk of damage in this installation position because the risk of collision with obstacles is decreased there, and the flow of material is scarcely impeded as a result of this installation position because the rocker arms are of highly compact design.

In accordance with one refinement of the invention, the drive train has a portion from the output shaft to the lower knife, in which portion the rocker arm engages around regions of the upper knife. This portion supports the upper knife towards the rear in a direction counter to the working direction, and in the process holds the upper and lower knives on one another. Here, the lower knife can be connected fixedly to the lower part of the surrounding portion, with the result that, during the operation of the cutting unit, the lower knife moves in the same direction as the encompassing portion, but the upper knife moves at least temporarily in the opposite direction. The portion can be of strip-shaped configuration, with the result that the supporting and pressing action is set not only in a punctiform manner, but rather over the length of the encompassing portion.

In accordance with one refinement of the invention, the upper knife and the lower knife are held on rocker arms which have the same length between their cutting unit-side rotational axis and the rotational axis, via which they are connected to the upper knife or the lower knife, as the rocker arms, via which the upper knife and the lower knife are connected to the mechanism. As a result of the identical length of the rocker arms, which are used for driving the upper and lower knives and for securing them and, due to this, the identical radius, at which the rocker arms rotate about the rotational axis, the upper and lower knives move very smoothly. Bending forces are also avoided in the upper and lower knives, which bending forces can occur when rocker arms with a different length are used.

In accordance with one refinement of the invention, rocker arms which hold the upper knife and hold the lower knife are arranged at a bearing point concentrically with respect to one another by way of their respective cutting unit-side rotational axes. In each case, one rocker arm for the upper knife and one rocker arm for the lower knife form a pair of rocker arms which are arranged concentrically with respect to one another. A plurality of pairs of rocker arms or all the pairs of rocker arms can be provided distributed over the cutting unit width with rotational axes, which are arranged concentrically with respect to one another. The holding forces which act on the upper and lower knives do not differ as a result. One bearing point for mounting the two rocker arms is sufficient at every position, at which the upper and lower knives are connected to the cutting unit, as a result of which the construction complexity is reduced. In accordance with a modular system, identical rocker arms can be used for securing the upper and lower knives.

In accordance with one refinement of the invention, at their frame-side and/or knife-side end, the rocker arms have a buffer element which builds up restoring forces. The buffer element can be, for example, a shaped part made from an elastomeric material such as a natural or synthetic rubber, which shaped part absorbs force peaks, in particular, in the end positions of the associated rocker arm and outputs the restoring forces which are built up in the process again when the rocker arm moves in the opposite direction again. As a result, the double knife cutting system runs more smoothly and has a longer service life, and the risk of damage by foreign bodies which get clamped between the knife blades is lower because force peaks are absorbed by the buffer elements. Instead of a buffer element made from an elastomeric material, metallic springs can also be used as a buffer element.

In accordance with one refinement of the invention, the knife blades are arranged with a different blade pitch on the upper and lower knife. As a result of the different spacings of the blades, which are arranged on the upper and lower knives, the force peaks which occur between the knife blades as a result of a respective cut at a cutting location are distributed via a revolution of the mechanism to a plurality of angular degrees of a revolution, with the result that a great number of or all the force peaks which occur by cuts on knife pairs are not added at one angular degree. As a result, the drive train is preserved, can be designed for lower forces, and can be operated more smoothly.

Further features of the invention result from the claims, the figures and the description of the figures. All the features and combinations of features which are mentioned above in the description and the features and combinations of features which are mentioned in the following text in the description of the figures and/or are shown only in the figures can be used not only in the respective specified combination, but rather also in other combinations or else on their own. These and/or other objects, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Further modifications and embodiments of the invention can be derived from the following description of the subject matter and the drawings.

The invention is now to be explained in more detail with reference to exemplary embodiments.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

In the drawings:

FIG. 1 shows a view of a cutting unit from a view obliquely from the front;

FIG. 2 shows an enlarged detailed view of the double knife cutting system;

FIG. 3 shows the upper and lower knives, which are held at the free ends by a plurality of supporting arms that are connected to the frame;

FIG. 4 shows an enlarged view of that region of the knife bar, in which a mechanism is arranged, and

FIG. 5 shows a sectional view through the region of the knife bar.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

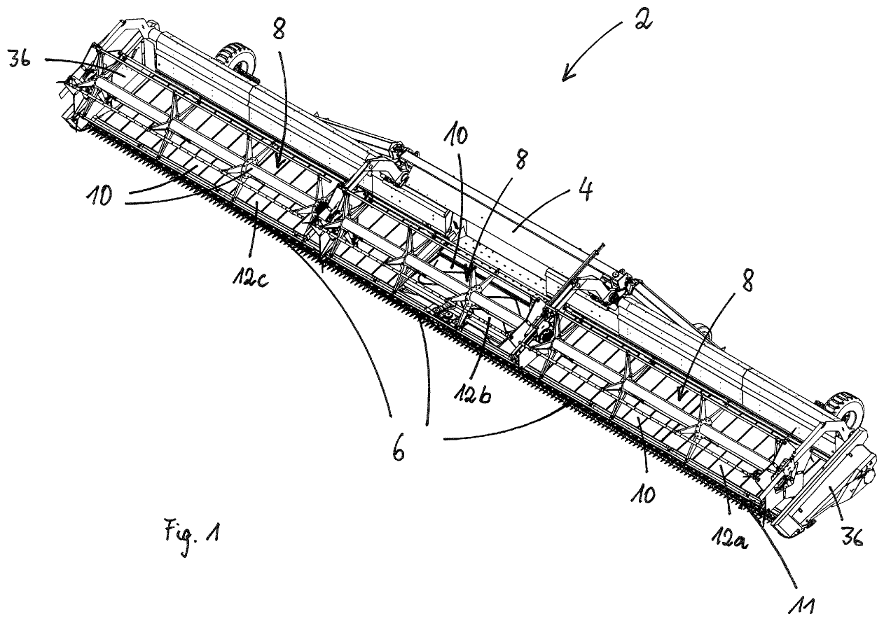

FIG. 1 shows a view of a cutting unit 2 from a view obliquely from the front. The cutting unit 2 is of a multiple-part configuration with a central part and two side parts which can be pivoted in relation to the central part, and has a frame 4, to which the knife bar 6 is connected. The harvested material, which is cut by the knife bar 6 is deposited on the depositing surface 8 and is conveyed away from there by means of one or a plurality of conveying apparatuses 10.

In the exemplary embodiment, the depositing surface 8 is situated on a total of three belt conveyors 12a, 12b, 12c, of which the two lateral belt conveyors 12a, 12c, during the harvesting work, convey the cut harvested material which is deposited on them from the outside to the inside onto the central belt conveyor 12b, and the latter conveys the harvested material deposited on it away rearwards in the direction of the feeder house of a combine harvester which is connected to the cutting unit 2. As a result of their method of operation, the belt conveyors 12a, 12b, and 12c not only configure the depositing surface 8, but rather at the same time also conveying apparatuses 10. One example of a further conveying apparatus 10 is the reel which is arranged over and above the knife bar 6 such that it can be driven rotationally. It dips with the reel prongs into the supply of the cereal crops to be harvested during the harvesting work and moves the cut cereal crops in the direction of the depositing surface 8. The cutting unit 2 has a drive apparatus, by way of which a drive force is transmitted to the double knife cutting system 11 with the upper knife 22 and the lower knife 24 and to the conveying apparatuses 10. The side walls 36, which at the same time define the working width of the cutting unit 2 are situated at the lateral ends of the cutting unit 2.

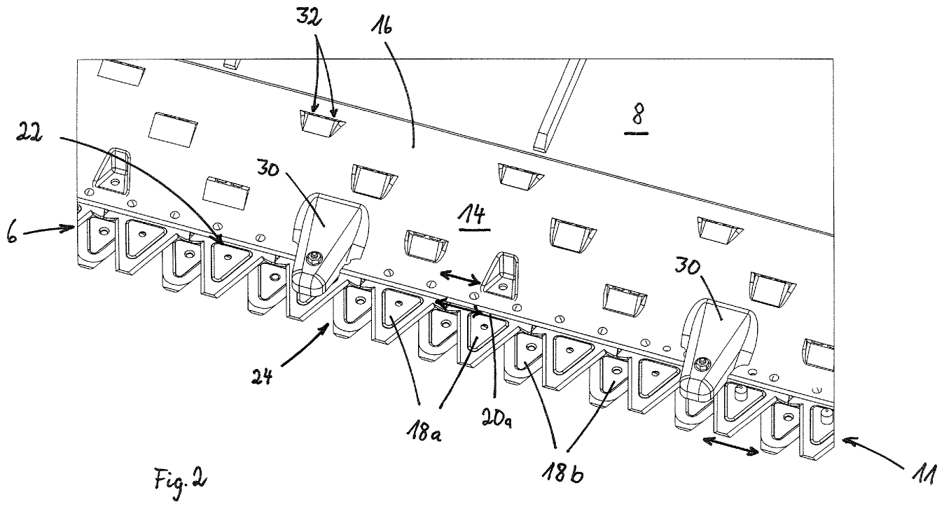

FIG. 2 shows an enlarged detailed view of the double knife cutting system 11, which is arranged in the region of the knife bar 6. In the case of the double knife cutting system 11, a first part of the knife blades 18a which are present on the cutting unit 2 are fastened to a first knife back 20a, and this first part of the knife blades 18a forms the upper knife 22 together with the first knife back 20a, and a second part of the knife blades 18b which are present on the cutting unit 2 are fastened to a second knife back 20b, this second part of the knife blades 18b forming the lower knife 24 together with the second knife back 20b. The upper knife 22 and the lower knife 24 are driven in opposite directions, which results in a type of scissor-like cut in the region of the cutting edges of the knife blades 18a, 18b, which are moved towards one another, by way of which scissor-like cut the stalks of the harvested material are cut off.

A sliding surface 14 is configured on the cutting unit 2 in the transition region from the double knife cutting system 11 to the depositing surface 8. The sliding surface 14 guides the harvested material over the vertical and/or longitudinal offset between the upper and lower knives 22, 24 and the depositing surface 8. The sliding surface 14 is configured as a bar 16, which is connected in a stationary manner to the upper knife 22. When the upper knife 22 moves back and forth, the bar 16 and, therefore also the sliding surface 14 are correspondingly in motion.

Distributed transversely over the working width of the cutting unit 2, the bar 16 has a number of air outlet openings 32, which are oriented upwards and/or in the direction of the depositing surface 8. Air that exits from the air outlet openings 32 can capture harvested material which is falling down in the region of the sliding surface 14 and can blow it in the direction of the depositing surface 8, with the result that this harvested material does not fall onto the farmland soil in front of the knife bar 6 and is not lost.

Moreover, in the regions, in which rocker arms 34, 40 are situated, the bar 16 can also in each case have shaped coverings 30, which shield the rocker arms 34, 40 against harvested material and dirt. The coverings 30 can be configured in a manner which is formed in one part in the bar 16, as a result of which the assembly is simplified and joints and edges are avoided, at which harvested material might get jammed and might build up to form material clumps.

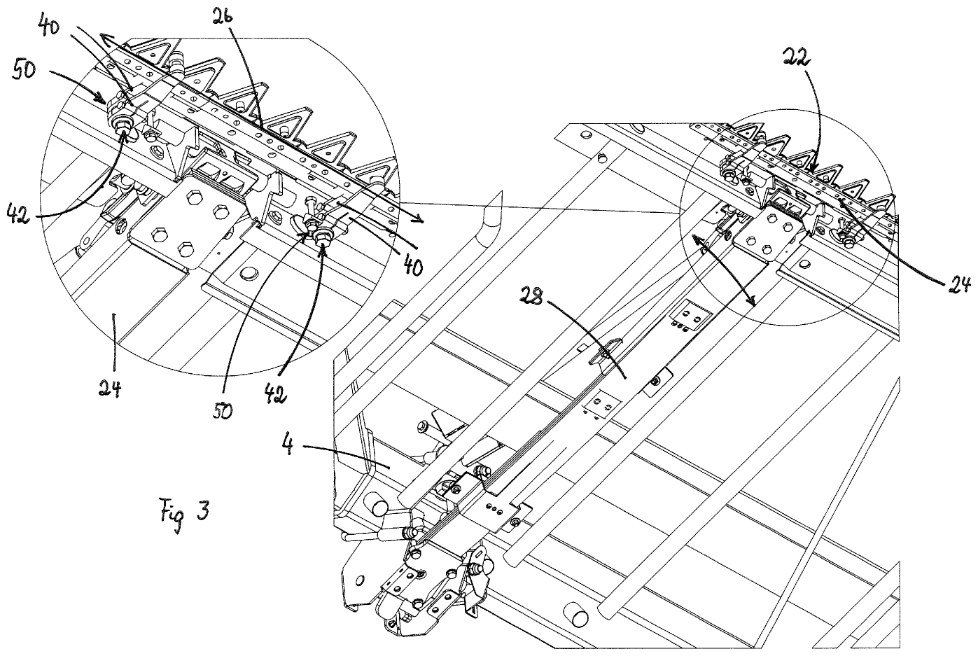

It is shown in FIG. 3 that the upper and lower knives 22, 24 are held over their lengths in the direction of extent 26 at free ends by a plurality of supporting arms 28, which are connected to the frame 4 and can be moved with their free ends into vertical positions which are different from one another. FIG. 3 shows by way of example one of the supporting arms 28 which is configured in the exemplary embodiment as a leaf spring. The mobility of the supporting arm 28 is indicated by way of a corresponding double arrow in the region of its free end. As a result of the movable height securing of the upper and lower knives 22, 24, they can be adapted in a flexible manner to an uneven ground contour during the harvesting work of the harvesting machine. FIG. 3 also shows that the rocker arms 40, which hold the upper knife 22 and hold the lower knife 24 are arranged at a bearing point 50 with their respective cutting unit-side rotational axes 42 concentric with respect to one another.

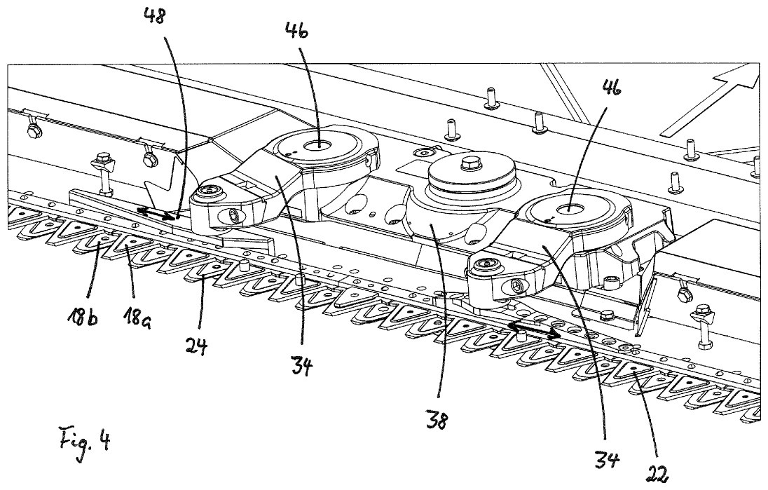

FIG. 4 shows an enlarged view of the region of the knife bar 6, in which a mechanism 38 is arranged. The mechanism 38 is arranged in the cutting unit 2 at a location between the side walls 36 of the cutting unit 2, preferably at least approximately centrally between the side walls 34 in the case of only one mechanism 38 in the cutting unit 2. In the mechanism 38, a rotating drive rotational speed which is introduced by a drive shaft into the mechanism 38 is converted into an oscillating to and fro movement of the rocker arms 34, to which the upper knife 22 and the lower knife 24 of the double knife cutting system 11 are drive-connected. It can be seen in FIG. 4 that the output shafts 46 are guided out of the mechanism housing to the outside on the upper side of the mechanism 38 in order to drive the rocker arms 34. There, they are connected to the rocker arms 34 which extend from a plane above the plane of the upper and lower knives 22, 24 from the output shafts 46 in the direction of the upper and lower knives 22, 24. The rocker arms 34 push the upper and lower knives 22, 24 to and fro, as a result of which the knife blades 18a, 18b cut harvested material which is situated between the knife blades 18a, 18b. In this way, the two knives 22, 24 can be driven in an oscillating manner by way of only one mechanism 38. The balance of the cutting unit 2 about its longitudinal center axis is maintained in full by way of the at least approximately central arrangement of the mechanism 38. In addition, the lateral edges of the cutting unit 2 are relieved of the weight of the mechanism 38 and the associated drive train to the mechanism 38, which has a considerably relieving effect on the overall construction, in particular, in the case of relatively great working widths of the cutting unit 2 of more than 8 meters, because, as a result, the frame 4 can also be of lighter configuration. FIG. 4 also shows that the drive train has a portion 48 from the output shaft 46 to the lower knife 24, in which portion 48 the rocker arm 46 engages in regions around the upper knife 22.

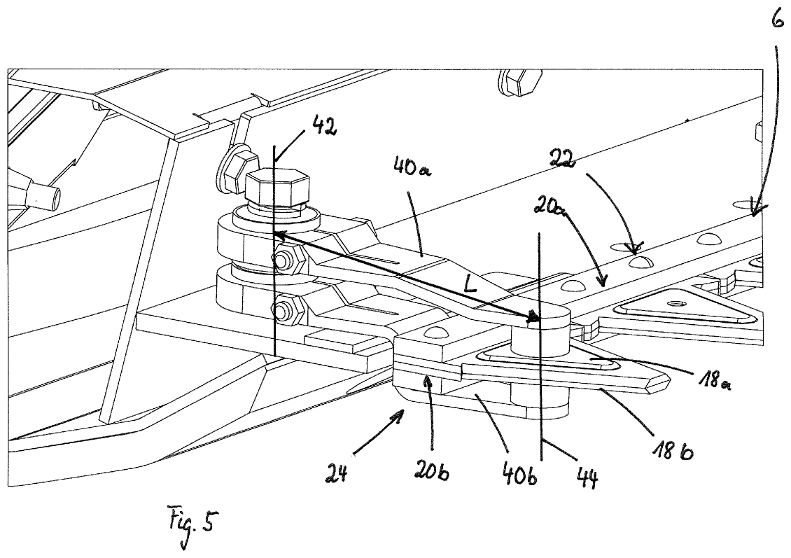

FIG. 5 shows a sectional view through the region of the knife bar 6. The upper knife 22 and the lower knife 24 are held there on rocker arms 40 which, between their cutting unit-side rotational axis 42 and the rotational axis 44, by which they are connected to the upper knife 22 or the lower knife 24, have the same length L as the rocker arms 34, via which the upper knife 22 and the lower knife 24 are connected to the mechanism 38. The rocker arms 40a, 40b, which hold the upper knife 22 and the lower knife 24 are arranged with their respective cutting unit-side rotational axes 42 concentrically with respect to one another.

The invention is not restricted to the above exemplary embodiment. It does not pose any difficulties to a person skilled in the art to modify the exemplary embodiment in a way which appears suitable to them, in order to adapt it to a specific application.

From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 2 | Cutting unit |
| 4 | Frame |
| 6 | Knife bar |
| 8 | Depositing surface |
| 10 | Conveying apparatus |
| 11 | Double knife cutting system |
| 12a | First lateral belt conveyor |
| 12b | Central belt conveyor |
| 12c | Second lateral belt conveyor |
| 14 | Sliding surface |
| 16 | Bar |
| 18a | First part of the knife blades |
| 18b | Second part of the knife blades |
| 20a | First knife back |
| 20b | Second knife back |
| 22 | Upper knife |
| 24 | Lower knife |
| 26 | Direction of extent |
| 28 | Supporting arm |
| 30 | Covering |
| 32 | Air outlet opening |
| 34 | Rocker arm (mechanism) |
| 36 | Side wall |
| 38 | Mechanism |
| 40 | Rocker arm (holder) (broken down further into rocker arm |
| | components 40a and 40b in FIG. 5) |
| 42 | Cutting unit-side rotational axis |
| 44 | Knife-side rotational axis |
| 46 | Output shaft |
| 48 | Portion (broken down further into portions 48a and 48b in FIG. 5) |
| 50 | Bearing point |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein, refers to slight variations in numerical quantities with respect to any quantifiable variable. Inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes a structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

What is claimed is:

1. A cutting unit (2) for attachment to a combine harvester which comprises a frame (4), a knife bar (6), a depositing surface (8) for depositing the cut stalk material, conveying apparatuses (10) for conveying away the cut stalk material, drive apparatuses for driving the knife bar (6) and the conveying apparatuses (10), and a sliding surface (14), inclined obliquely in the conveying direction of the harvested crops, in the transition region from the knife bar (6) to the depositing surface (8), further including a double knife cutting system (11) that is configured on the knife bar (6), in the case of which double knife cutting system (11) a first part of the knife blades (18a) present on the cutting unit (2) are fastened to a first knife back (20a), this first part of the knife blades (18a) together with the first knife back (20a) forming the upper knife (22), and a second part of the knife blades (18b) present on the cutting unit (2) being fastened to a second knife back (20b), this second part of the knife blades (18b) together with the second knife back (20b) forming the lower knife (24), the upper knife (22) and the lower knife (24) being driven in opposite directions, and the sliding surface (14) being configured as a bar (16) is connected in a stationary manner to the upper knife (22).

2. The cutting unit (2) for attachment to a combine harvester according to claim 1, wherein the upper knife (22) and lower knife (24) are held over their length in the direction of extent (26) at the free ends of a plurality of supporting arms (28) which are connected to the frame (4) and can be moved with their free ends into height positions that are different from one another.

3. The cutting unit (2) for attachment to a combine harvester according to claim 1, wherein that the depositing surface (8) is configured on the upwardly pointing side of one or more belt conveyors (12) which are driven in circulation.

4. The cutting unit (2) for attachment to a combine harvester according to claim 1, wherein the bar (16) has a number of air outlet openings (32) which are oriented upwards and/or in the direction of the depositing surface (8) and distributed transversely over the working width.

5. The cutting unit (2) for attachment to a combine harvester according to claim 1, wherein the coverings (30) are formed in each case in the bar (16) in the regions, in which rocker arms (34, 40) are situated, which coverings (30) shield the rocker arms (34, 40) against harvested crops and dirt.

6. The cutting unit (2) for attachment to a combine harvester according to claim 1, wherein the cutting unit (2) is of multiple-part configuration, and the bar (16) is of flexible and/or split configuration at the joints between the cutting unit parts.

7. The cutting unit (2) for attachment to a combine harvester according to claim 1, wherein the upper knife (22) and lower knife (24) of the double knife cutting system (11) are drive-connected via rocker arms (34) to a mechanism (38) which is arranged at a location between the side walls (36) of the cutting unit (2).

8. The cutting unit (2) for attachment to a combine harvester according to claim 7, wherein the output shafts (46) for driving the rocker arms (34) are guided outwards out of the mechanism housing on the upper side of the mechanism (38) and the rocker arms (34) extend in a plane above the plane of the upper knife (22) and lower knife (24) from the output shafts (46) in the direction of the upper knife (22) and lower knife (24).

9. The cutting unit (2) for attachment to a combine harvester according to claim 7, wherein the drive train has a portion (48) from the output shaft (46) to the lower knife (24), in which portion (48) the rocker arm (46) engages around regions of the upper knife (22).

10. The cutting unit (2) for attachment to a combine harvester according to claim 7, wherein the upper knife (22) and the lower knife (24) are held on rocker arms (40) which have the same length between their cutting unit-side rotational axis (42) and the knife side rotational axis (44), via which they are connected to the upper knife (22) or the lower knife (24), as the rocker arms (34), via which the upper knife (22) and the lower knife (24) are connected to the mechanism (38).

11. The cutting unit (2) for attachment to a combine harvester according to claim 1, further comprising rocker arms (40) which hold the upper knife (22) and hold the lower knife (24) are arranged at a bearing point (50) concentrically with respect to one another by way of their respective cutting unit-side rotational axes (42).

12. The cutting unit (2) for attachment to a combine harvester according to claim 1, wherein the rocker arms (46) have a buffer element that builds up restoring forces at their frame-side and/or knife-side end.

13. The cutting unit (2) for attachment to a combine harvester according to claim 1, wherein the first part of the knife blade (18a) and the second part of the knife blades (18b) are arranged with a different blade pitch on the upper knife (22) and the lower knife (24).
